(19) United States
(12) Patent Application Publication
(10) Pub. No.: US 2022/0241743 A1
(43) Pub. Date: Aug. 4, 2022

(54) Mixing device and vessel cleaning

(71) Applicant: Lyle J. Kelly, Maryville, TN (US)

(72) Inventor: Lyle J. Kelly, Maryville, TN (US)

(21) Appl. No.: 17/644,180

(22) Filed: Dec. 14, 2021

Related U.S. Application Data
(60) Provisional application No. 63/199,908, filed on Feb. 2, 2021.

(51) Int. Cl. B01F 35/12; A46B 7/00; A46D 1/00; B08B 1/00; B08B 9/087

(52) U.S. Cl. CPC B01F 35/121; A46B 7/00; B08B 2209/08; B08B 1/002; B08B 9/087; A46D 1/0207

(57) ABSTRACT

A scrubbing apparatus that is adapted to clean both a mixing paddle and an inner surface of a mixing vessel having an inner diameter and a depth. The scrubbing apparatus has a central structure. Outward facing wipes are attached to the central structure, where distal ends of the outward facing wipes form a perimeter having a diameter that is no less than the inner diameter of the mixing vessel. Inward facing wipes are attached to the central structure, where distal ends of the inward facing wipes are disposed proximate one another.

### FIELD

The present disclosure relates generally to an apparatus and method for simultaneously cleaning a paddle, stirrer, beater, or whisk type mixing device and for cleaning a bucket, pail, or other mixing vessel. More particularly, the present disclosure relates to an apparatus and method for simultaneously cleaning both a mixing vessel and a mixing device while the mixing device remains attached to the driving motor.

### INTRODUCTION

Several industries and trades use motor-driven mixing machines that rotate the shaft of an attached mixing device, which is often referred to as a paddle, stirrer, beater, or whisk. After the mixing process, a residue of the material being mixed tends to remain on the surfaces and within the crevices of the mixing device and on the inner walls of the mixing vessel.

Many, if not removed promptly, can dry and adhere to the surface of the mixing device and the mixing vessel. For this reason, mixing devices and mixing vessels are preferably cleaned often to avoid any build-up of a residue, more onerous cleaning maintenance, or premature replacement of the mixing device.

Manually cleaning the surface and crevices of a mixing device while it is engaged with the motor-driven mixing machine can be a safety hazard, such as if the mixing machine were accidentally powered on while the mixing device was being handled. For this reason, the additional step of detaching the mixing device from the motor-driven mixing machine should be taken before cleaning by hand.

Many commonly-used motorized mixing machines—drills, for example require a specific tool, referred to as a key, which opens and closes a chuck in order to detach and reattach the mixing device for cleaning. These keys regularly become worn, broken, or are lost, making detachment of the mixing device more difficult. As a result, the task of manually cleaning the mixing device is often performed while the mixing device is still attached to the mixing machine or drill.

A common method of cleaning a mixing device while it is attached to the driving motor is to spray the residue off with water from a water hose or faucet. The residue from a mixed material such as cementitious powder with water or latex additives can be difficult to remove from the mixing device, and doing so with a water hose or faucet is time-consuming and uses excessive amounts water.

What is needed, therefore, is a system that tends to reduce issues such as those introduced above, at least in part.

### SUMMARY

The above and other needs are met by a scrubbing apparatus that is adapted to clean both a mixing paddle and an inner surface of a mixing vessel having an inner diameter and a depth. The scrubbing apparatus has a central structure. Outward facing wipes are attached to the central structure, where distal ends of the outward facing wipes form a perimeter having a diameter that is no less than the inner diameter of the mixing vessel. Inward facing wipes are attached to the central structure, where distal ends of the inward facing wipes are disposed proximate one another.

In various embodiments according to this aspect of the invention, there are a total of four outward facing wipes. In some embodiments, there are a total of four inward facing wipes. In some embodiments, the outward facing wipes extend along the central structure for a distance substantially equal to the depth of the mixing vessel. In some embodiments, the inward facing wipes extend along the central structure for a distance substantially equal to the depth of the mixing vessel. In some embodiments, the central structure, outward facing wipes, and inward facing wipes are formed of plastic. In some embodiments, the central structure is formed as a drum. In some embodiments, the outward facing wipes are formed of brushes with bristles. In some embodiments, the inward facing wipes are formed of brushes with bristles.

### DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1A is an exploded, perspective view of a scrubbing apparatus assembly according to an embodiment of the present disclosure.

FIG. 1B is a perspective view of the scrubbing apparatus assembly according to an embodiment of the present disclosure.

FIG. 1C is a top view of the scrubbing apparatus assembly according to an embodiment of the present disclosure.

FIG. 2A is a side view of the scrubbing apparatus according to an embodiment of the present disclosure.

FIG. 2B is a top view of the scrubbing apparatus according to an embodiment of the present disclosure.

FIG. 3A is a perspective view of a soiled mixing device, a soiled mixing vessel, and the scrubbing apparatus assembly according to an embodiment of the present disclosure.

FIG. 3B is a perspective view of the scrubbing apparatus as disposed in the soiled mixing vessel, and covered with the specialized lid according to an embodiment of the present disclosure.

FIG. 3C is a perspective view of the mixing device and mixing vessel after being cleaned by use of the scrubbing apparatus assembly according to an embodiment of the present disclosure.

### DESCRIPTION

The present disclosure describes an apparatus and method for cleaning both a mixing device and a mixing vessel either separately or simultaneously. The scrubbing apparatus is rotated by the mixing device inside of a mixing vessel. In some embodiments a specialized lid is attached to the mixing vessel. The specialized lid allows the mixing device to be inserted and removed freely from the mixing vessel as needed, while at least partially enclosing the scrubbing apparatus, cleaning solution, and the residual debris of the mixture that is removed during this process.

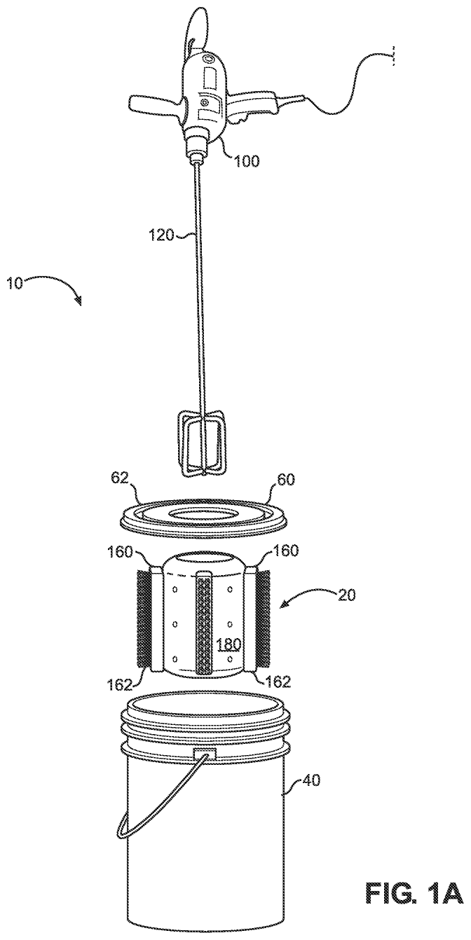

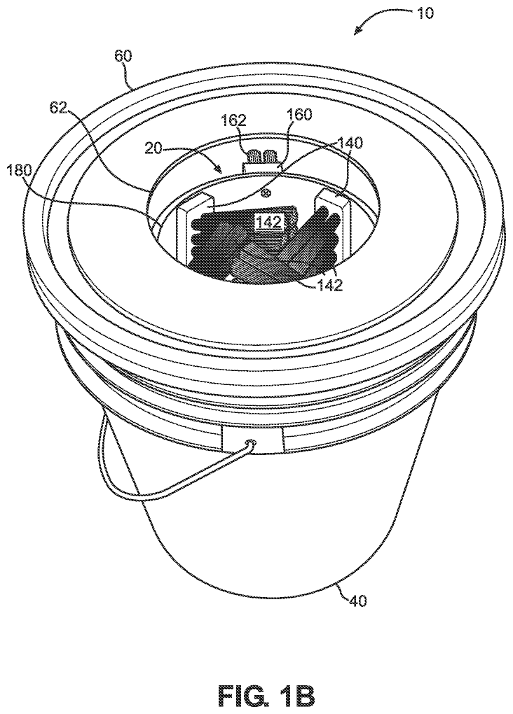

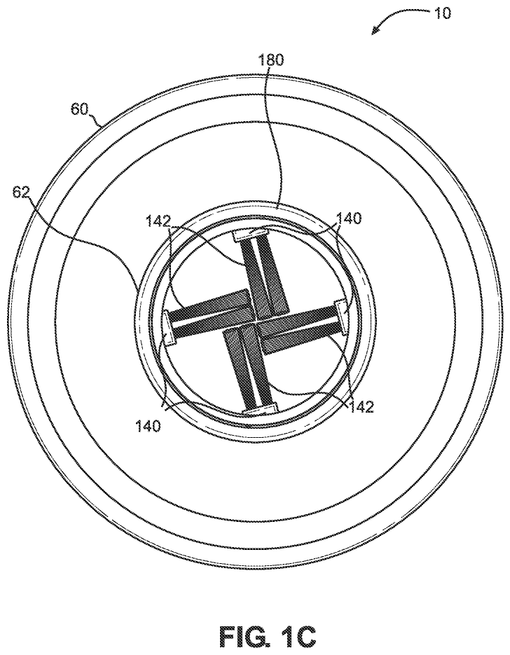

Referring now to FIGS. 1A, 1B, and 1C, the exemplary components of a scrubbing apparatus assembly 10 are illustrated. In this particular embodiment, the scrubbing apparatus assembly 10 includes, but is not limited to, a scrubbing apparatus 20 and a specialized lid 60. Also depicted are a drill 100 with an attached mixing device 120, which in the embodiments depicted is a paddle.

The scrubbing apparatus 20 has a central structure 180, which in the embodiments as depicted in the figures is a drum. However, other embodiments include but are not limited to a cage such as can be formed of plastic, metal, or wire, or some other form of skeletal structure that can support the wipes as described hereinafter.

The drum 180 includes wipes that are attached to both the exterior of the drum 180 and the interior of the drum 180. In the embodiments as depicted in the figures, the wipes are brushes with bristles. In other embodiments the wipes are one or more of fins, squeegees, scrapers, rags, sponges, and blades. In other embodiments the wipes include a roller that incorporates one of the aforementioned forms of the wipe, and which rotate opposite the mixing device 120 when the mixing device 120 is driven within the scrubbing apparatus 20.

Thus, in the embodiment depicted in FIGS. 1A, 1B, and 1C, brushes 140 are attached to the interior of the drum 180, and brushes 160 are attached to the exterior of the drum 180. The brushes 140 include bristles 142, and the brushes 160 include bristles 162. The size, number, length, orientation, and positions of the brushes 140 and 160 as depicted are representative, and not limited to the various configurations as depicted in the figures. In some embodiments the bristles 142 and 162 are attached directly to the drum 180. In some embodiment that bristles 142 and 162 are merely the two ends of bristles that pass through the drum 180 and are molded to the drum 180 at a generally central location along the lengths of the bristles 142 and 162.

After mixing a material with the mixing device 120, the mixing device 120 will be soiled. The mixing device 120 can then be inserted through the hole 62 of the specialized lid 60 and into the matrix of the inner bristles 142 of the scrubbing apparatus 20. The drill 100 can then be powered to rotate the mixing device 120, forcing the scrubbing apparatus 20 to spin within the mixing vessel 40. The surfaces and crevices of the soiled mixing device 120 are scrubbed by the inner bristles 142 with the spinning action of the mixing device 120 within the scrubbing apparatus 20, thereby removing the residue from the mixing device 120, while the outer bristles 162 of the outer brushes 160 remove the residue from the inner walls of the mixing vessel 40.

FIG. 1B is a perspective view of an embodiment 10 of the scrubbing apparatus assembly shown with the scrubbing apparatus 20 residing within the mixing vessel 40 with a specialized lid 60 attached. In this illustration, one of the four outer brushes 160 is visible, shown attached to the drum 180, and the bristles 162 of the outer brushes 160 extend outward horizontally to come in contact with or in close proximity to the inner walls of the mixing vessel 40.

FIG. 1C is a top view of an embodiment 10 of the scrubbing apparatus assembly of FIGS. 1A and 1B. This view illustrates how the four inner brushes 140 are arranged and attached to the drum 180 with bristles 142 extending horizontally inward from the inner brushes 140 to a central axis, where they can come into contact with a mixing device 120. The drill 100 and mixing device 120 have been omitted from FIGS. 1B and 1C to avoid obstructing those views.

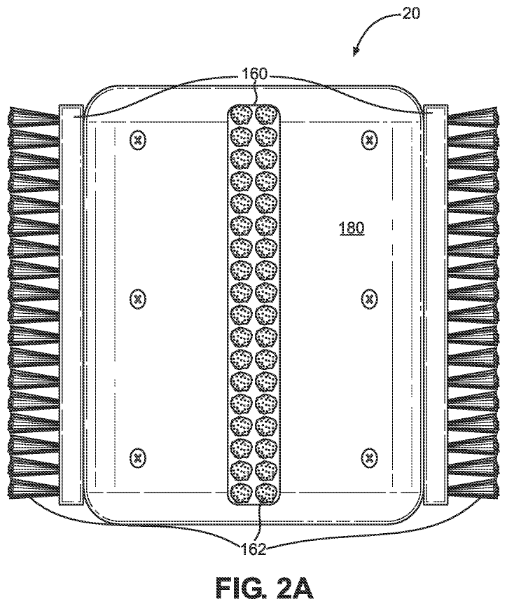

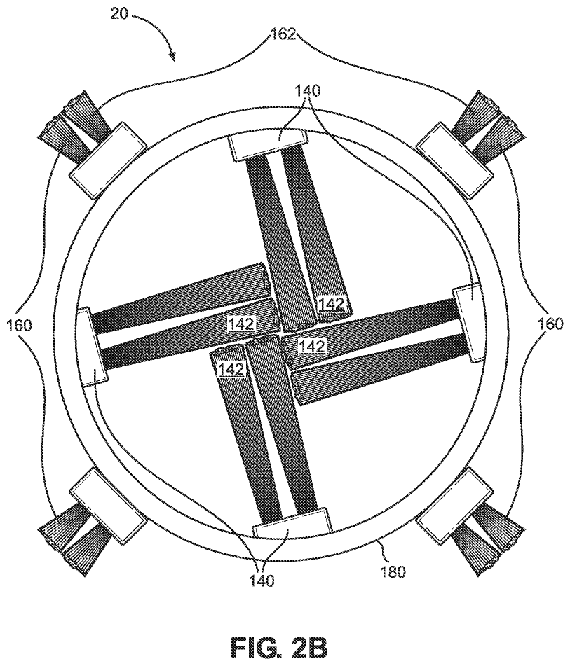

Referring to FIGS. 2A and 2B, detailed diagrams of one embodiment of the scrubbing apparatus 20 are shown, including four outer brushes 160—three being visible from the side view FIG. 2A—four inner brushes 140, and the drum 180 to which the brushes 140 and 160 are attached. The outer brushes 160 and the inner brushes 140 are shown with a vertical orientation attached to the drum 180.

FIG. 2B illustrates the inner brushes 140 having a vertical orientation and having a height equal to or less than the internal height of the mixing vessel 40 when the specialized lid 60 is attached. The specific quantity, orientation, material, shape, and manufacturing method of the outer brushes 160, the outer bristles 162, the inner brushes 140, the inner bristles 142, and the drum 180 are not limited to the embodiments as depicted in the figures.

For example, the outer brushes 160 and inner brushes 140 may be eliminated by securing the outer bristles 162 and inner bristles 142 directly to a drum 180 of rigid material, such as plastic, and may be oriented diagonally, or intermittently placed in such a way that the ends of the outer bristles 162 maintain overlapping paths when the scrubbing apparatus 20 is rotated within the mixing vessel 40.

The outer bristles 162 and inner bristles 142 illustrated in this particular embodiment may be formed of many thin filaments of polyethylene plastic, while other embodiments of these particular components can be manufactured with other resilient materials such as a different plastic, a rubber, or a metal.

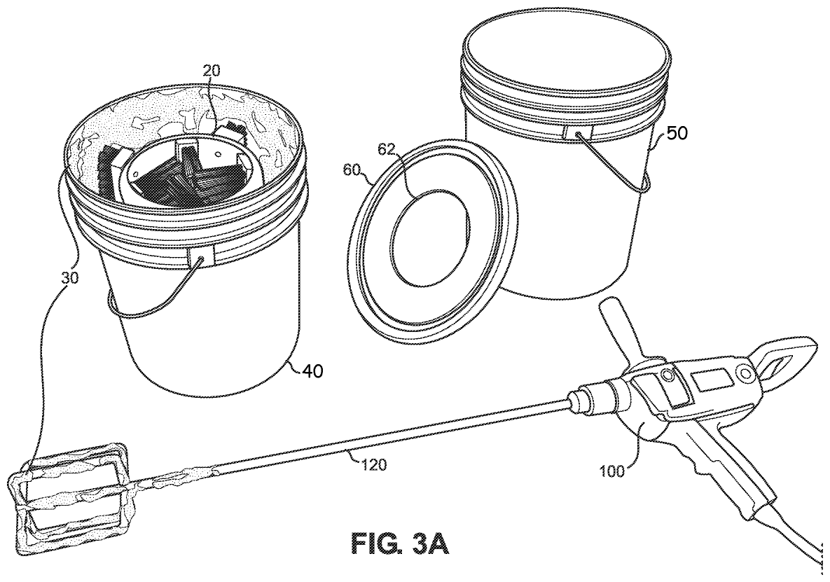

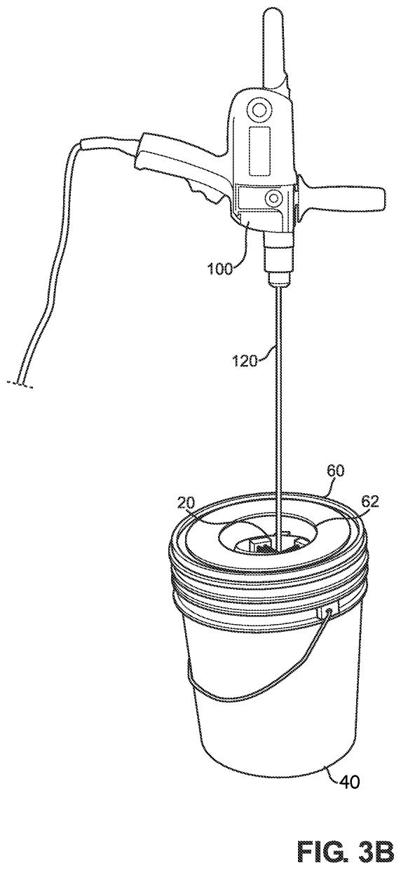

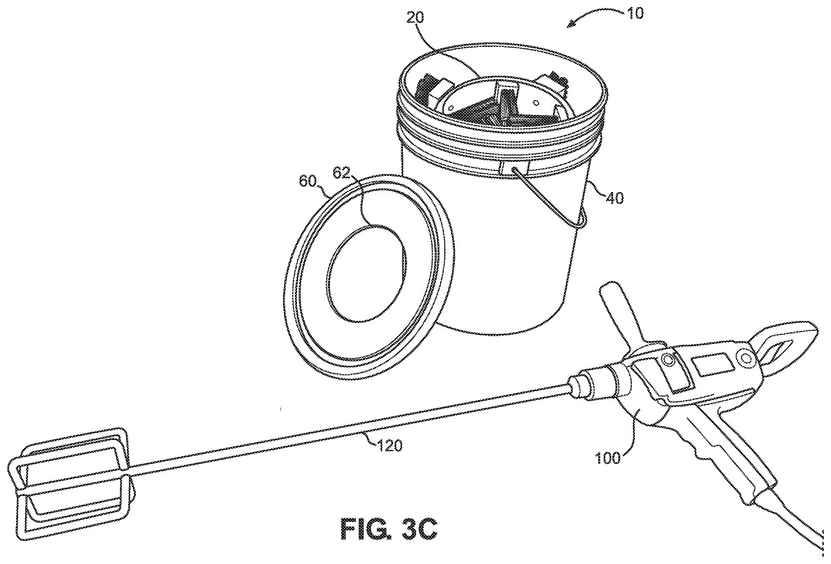

FIGS. 3A through 3C progressively illustrate one particular process of using the scrubbing apparatus assembly 10 with a mixing device 120 and mixing vessel 40, both of which have been soiled with a residual material 30.

FIG. 3A illustrates the scrubbing apparatus 20, shown contained in a soiled mixing vessel 40 before the specialized lid 60 has been secured to the mixing vessel 40. In this particular embodiment, the mixing vessel 40 is shown as a common five-gallon bucket, though in other embodiments the mixing vessel 40 may be any type of vessel compatible with the scrubbing apparatus 20, and is sufficient to contain the materials during mixing with a mixing device 120. The specialized lid 60 may be made from a pliable material such as, but not limited to, silicone rubber, which could conform to fit a variety of different-sized vessels 40.

This embodiment depicted shows the specialized lid 60 having a circular hole 62 in the center of the lid 60, where the circular hole 62 is about six inches in diameter, and allows the insertion of many common mixing devices. Other embodiments have a different diameter hole or a differently-shaped hole to accommodate other sizes and other types of mixing devices. In this particular embodiment, the lid 60 at the perimeter of the circular hole 62 is flat. Other embodiments may employ a fillet or funnel-shaped lip to direct the contents of the vessel 40 in which the scrubbing apparatus 20 is being used back down toward the bottom of the vessel 40. In other embodiments, the hole 62 includes a perforated pliable sheet that is attached at the periphery of the hole 62, to improve the containment of at least one of the materials being mixed, the residue, and the solution during the cleaning process.

The aforementioned embodiment of the specialized lid 60 made from a pliable material—such as, but not limited to, silicone rubber—can also incorporate a perforation in lieu of the hole 62 for improved containment of at least one of the material being mixed, the residue, and the solution during the cleaning process, allowing a mixing device to be inserted into and removed from the vessel containing the scrubbing apparatus.

In some embodiments a clean bucket 50 can be used with clean water and the scrubbing apparatus 20 to clean the mixing device 120, either before or after cleaning the mixing vessel 40. In other embodiments, cleaning of the mixing device 120 is performed in the mixing vessel 40.

FIG. 3B illustrates the scrubbing apparatus 20 shown in a mixing vessel 40 with the specialized lid 60 secured to the mixing vessel 40. The soiled mixing device 120 of FIG. 3A is attached to a drill 100 and inserted through the hole 62 of the specialized lid 60 and into the scrubbing apparatus 20 through the matrix of the inner bristles 142. The drill 100 is then powered to rotate the mixing device 120, forcing the scrubbing apparatus 20 to spin within the mixing vessel 40. Subsequently, the soiled inner walls of the mixing vessel 40 are scrubbed by the outer bristles 162, and the surfaces and crevices of the soiled mixing device 120 are scrubbed by the inner bristles 142 by the spinning action of the scrubbing apparatus 20, removing the residue from both the mixing device 120 and the mixing vessel 40.

FIG. 3C illustrates a mixing vessel 40 and a drill 100 with an attached mixing device 120 after being cleaned using the scrubbing apparatus assembly 10.

As used herein, the phrase “at least one of A, B, and C” means all possible combinations of none or multiple instances of each of A, B, and C, but at least one A, or one B, or one C. For example, and without limitation: Ax1, Ax2+Bx1, Cx2, Ax1+Bx1+Cx1, Ax1+Bx12+Cx113. It does not mean Ax0+Bx0+Cx0.

The various exemplary embodiments that have been illustrated and described herein are not intended to limit the scope of the disclosure. It is to be understood that numerous variations, alterations, and applications have been contemplated, as they would occur to anyone of ordinary skill in the relevant art having possession of this disclosure, and are to be considered within the scope of the disclosure.

The foregoing description of embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A scrubbing apparatus adapted to clean both a mixing paddle and an inner surface of a mixing vessel having an inner diameter and a depth, the scrubbing apparatus comprising:
a central structure,
outward facing wipes attached to the central structure, where distal ends of the outward facing wipes form a perimeter having a diameter that is no less than the inner diameter of the mixing vessel,
inward facing wipes attached to the central structure, where distal ends of the inward facing wipes are disposed proximate one another.

2. The scrubbing apparatus of claim 1, wherein there are a total of four outward facing wipes.

3. The scrubbing apparatus of claim 1, wherein there are a total of four inward facing wipes.

4. The scrubbing apparatus of claim 1, wherein the outward facing wipes extend along the central structure for a distance substantially equal to the depth of the mixing vessel.

5. The scrubbing apparatus of claim 1, wherein the inward facing wipes extend along the central structure for a distance substantially equal to the depth of the mixing vessel.

6. The scrubbing apparatus of claim 1, wherein the central structure, outward facing wipes, and inward facing wipes are formed of plastic.

7. The scrubbing apparatus of claim 1, wherein the central structure is formed as a drum.

8. The scrubbing apparatus of claim 1, wherein the outward facing wipes are formed of brushes with bristles.

9. The scrubbing apparatus of claim 1, wherein the inward facing wipes are formed of brushes with bristles.

10. A scrubbing apparatus adapted to clean both a mixing paddle and an inner surface of a mixing vessel having an inner diameter and a depth, the scrubbing apparatus comprising:
a drum having an inner surface and an outer surface,
outer brushes attached to the outer surface of the drum,
outer bristles depending radially outward from the outer brushes and the drum, where distal ends of the outer bristles form a perimeter having a diameter that is no less than the inner diameter of the mixing vessel,
inner brushes attached to the inner surface of the drum, and
inner bristles depending radially inward from the inner brushes and the drum, where distal ends of the inner bristles abut one another.

11. The scrubbing apparatus of claim 10, wherein there are a total of four outer brushes.

12. The scrubbing apparatus of claim 10, wherein there are a total of four inner brushes.

13. The scrubbing apparatus of claim 10, wherein the outer brushes extend along the drum for a distance substantially equal to the depth of the mixing vessel.

14. The scrubbing apparatus of claim 10, wherein the inner brushes extend along the drum for a distance substantially equal to the depth of the mixing vessel.

15. The scrubbing apparatus of claim 10, wherein the drum, outer brushes, and inner brushes are formed of plastic.

16. The scrubbing apparatus of claim 10, wherein the outer bristles and the inner bristles are formed of plastic.

17. A scrubbing apparatus adapted to clean both a mixing paddle and an inner surface of a mixing vessel having an inner diameter and a depth, the scrubbing apparatus comprising:
a drum formed of plastic and having an inner surface and an outer surface,
four outer brushes formed of plastic and attached to the outer surface of the drum,
outer bristles depending radially outward from the outer brushes and the drum, where distal ends of the outer bristles form a perimeter having a diameter that is no less than the inner diameter of the mixing vessel,
four inner brushes formed of plastic and attached to the inner surface of the drum, and
inner bristles depending radially inward from the inner brushes and the drum, where distal ends of the inner bristles abut one another.

18. The scrubbing apparatus of claim 17, wherein the outer brushes extend along the drum for a distance substantially equal to the depth of the mixing vessel.

19. The scrubbing apparatus of claim 17, wherein the inner brushes extend along the drum for a distance substantially equal to the depth of the mixing vessel.

20. The scrubbing apparatus of claim 17, wherein the outer bristles and the inner bristles are formed of plastic.
